(19) United States
(12) Patent Application Publication
(10) Pub. No.: US 2024/0311063 A1
(43) Pub. Date: Sep. 19, 2024

(54) SERVER DEVICE, CONTROL METHOD FOR SERVER DEVICE, AND PRINT CONTROL SYSTEM

(71) Applicant: SEIKO EPSON CORPORATION, Tokyo (JP)

(72) Inventors: Takashi SERA, SHIOJIRI-SHI (JP); Kohei YAMAMOTO, SHIOJIRI-SHI (JP); Katsuhito KITAHARA, MATSUMOTO-SHI (JP); Masayuki KOBAYASHI, FUJIMI-MACHI (JP); Masahiko MIZUTA, MATSUMOTO-SHI (JP)

(21) Appl. No.: 18/605,568

(22) Filed: Mar. 14, 2024

(30) Foreign Application Priority Data
Mar. 16, 2023 (JP) 2023-041683

(51) Int. Cl. G06F 3/12

(52) U.S. Cl. CPC G06F 3/1239; G06F 3/1207; G06F 3/121; G06F 3/1234; G06F 3/1288; G06F 3/1286; G06F 3/1287

(57) ABSTRACT

A server device includes: a communication unit configured to be able to communicate with a terminal device via an SNS server device providing a social networking service; and a controller configured to be able to control whether printing is available at a printing device or not. The controller receives a second print instruction at a second time point after receiving a first print instruction at a first time point by the communication unit, and makes printing based on the second print instruction unavailable at the printing device when it is determined that a time period from the first time point to the second time point is shorter than a predetermined time period.

The present application is based on, and claims priority from JP Application Serial Number 2023-041683, filed Mar. 16, 2023, the disclosure of which is hereby incorporated by reference herein in its entirety.

### BACKGROUND

### 1. Technical Field

The present disclosure relates to a server device, a control method for a server device, and a print control system.

### 2. Related Art

Printing information such as a plurality of images posted on a chat under the control of a control device is disclosed.

However, a control device described in JP-A-2020-115313 has a risk of executing printing that is not intended by a user, and therefore results in low convenience.

### SUMMARY

According to an aspect of the present disclosure, a server device includes: a communication unit configured to be able to communicate with a terminal device via an SNS server device providing a social networking service; and a control unit configured to be able to control whether printing is available at a printing device or not. The control unit receives a second print instruction at a second time point after receiving a first print instruction at a first time point by the communication unit, and makes printing based on the second print instruction unavailable at the printing device when it is determined that a time period from the first time point to the second time point is shorter than a predetermined time period.

According to another aspect of the present disclosure, a control method for a server device that is configured to be able to communicate with a terminal device via an SNS server device providing a social networking service and that is configured to be able to control whether printing is available at a printing device or not is provided. The control method includes: receiving a second print instruction at a second time point after receiving a first print instruction at a first time point; and making printing based on the second print instruction unavailable at the printing device when it is determined that a time period from the first time point to the second time point is shorter than a predetermined time period.

According to still another aspect of the present disclosure, a print control system includes: an SNS server device that provides a social networking service; a server device configured to be able to communicate with a terminal device via the SNS server device; and a printing device. The server device is configured to be able to control whether printing is available at the printing device or not, receives a second print instruction inputted to the terminal device, at a second time point, after receiving a first print instruction inputted to the terminal device, at a first time point, from the SNS server device, and makes printing based on the second print instruction unavailable at the printing device when it is determined that a time period from the first time point to the second time point is shorter than a predetermined time period.

### BRIEF DESCRIPTION OF THE DRAWINGS

FIG. 1 is a schematic view showing a configuration of a print control system.

FIG. 2 is a schematic view showing a functional configuration of the print control system.

FIG. 3 is a sequence chart showing processing in a first embodiment of a first server device.

FIG. 4 is a sequence chart showing processing in a second embodiment of the first server device.

FIG. 5 is a schematic view showing a message screen on a smartphone in the second embodiment.

FIG. 6 is a sequence chart showing processing in a third embodiment of the first server device.

FIG. 7 is a sequence chart showing processing in a fourth embodiment of the first server device.

### DESCRIPTION OF EMBODIMENTS

### 1. Configuration of Print Control System

### 1-1. Configuration of Print Control System

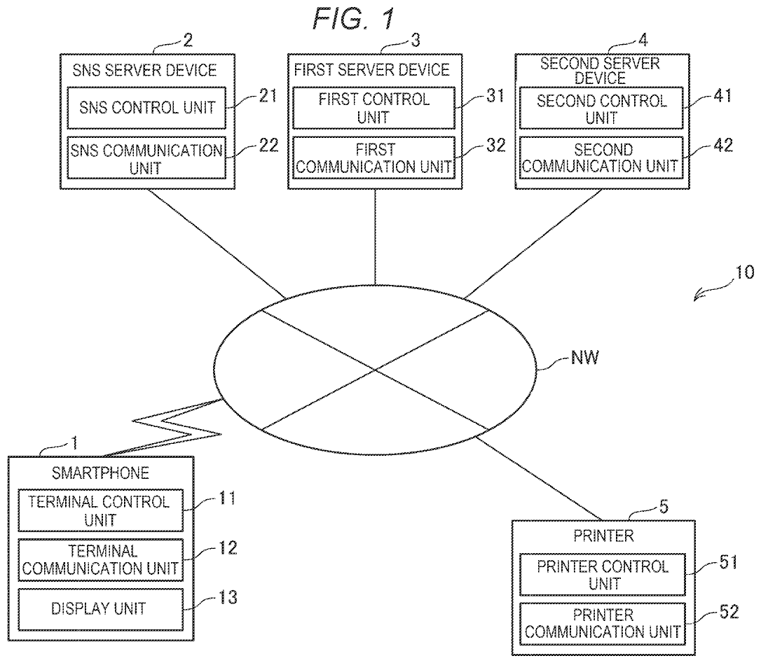

As shown in FIG. 1, a print control system 10 includes a smartphone 1 as a terminal device, an SNS server device 2, a first server device 3 as a server device, a second server device 4, and a printer 5 as a printing device.

As will be described later, the first server device 3 can include the second server device 4. In this case, the print control system 10 can include the smartphone 1, the SNS server device 2, and the first server device 3.

The smartphone 1, the SNS server device 2, the first server device 3, the second server device 4, and the printer 5 are communicably connected to each other via a network NW. The network NW is, for example, the internet.

The network NW may also be a LAN (local area network) or a WAN (wide area network).

The smartphone 1 has a terminal control unit 11, a terminal communication unit 12, and a display unit 13. As will be described later, the smartphone 1 sends a print instruction to the printer 5 sequentially via the SNS server device 2, the first server device 3, and the second server device 4.

The terminal control unit 11 has a processor such as a CPU (central processing unit) or a microcomputer. As the processor executes a control program, the terminal control unit 11 comprehensively controls each part of the smartphone 1. The terminal control unit 11 has a memory such as a ROM (read-only memory) that stores the control program executed by the processor, in a non-volatile manner, and a RAM (random-access memory) forming a work area of the processor.

The terminal communication unit 12 is a communication interface that has a communication circuit including a communication IC and that communicates with an external device. The terminal communication unit 12 may be a wired communication interface to which a cable can be coupled, or a wireless communication interface. For example, the terminal communication unit 12 may be a wired LAN interface conforming to Ethernet (trademark registered) or a wireless LAN interface conforming to the IEEE 802.11 standard.

The terminal communication unit 12 can also communicate with the SNS server device 2, for example, via a wireless network such as Wi-Fi (trademark registered).

The display unit 13 is a so-called touch panel. The display unit 13 has a display panel and a touch sensor. The display unit 13 is coupled to the terminal control unit 11.

The display panel displays various images under the control of the terminal control unit 11. The display panel is formed of, for example, an LCD (liquid crystal display).

The touch sensor detects a user's operation and outputs the detected operation to the terminal control unit 11. The touch sensor is integrated with the display panel. Specifically, the touch sensor is formed on an image display surface of the display panel.

The SNS server device 2 provides a social networking service. Hereinafter, the social networking service is simply referred to as SNS. The SNS is, for example, LINE (trademark registered).

The SNS server device 2 has an SNS control unit 21 and an SNS communication unit 22. The SNS server device 2 can send and receive a signal to and from the smartphone 1 and the first server device 3 by the SNS communication unit 22.

In the description below, accepting includes receiving, and transmitting includes sending.

For example, the SNS server device 2 can accept a print instruction JA from the smartphone 1 by the SNS communication unit 22. The SNS server device 2 also transmits the print instruction JA for the printer 5 accepted from the smartphone 1 to the first server device 3 by the SNS communication unit 22.

The print instruction JA represents the content of an instruction about printing for the printer 5. The print instruction JA is an example of a “print instruction”.

The SNS control unit 21 of the SNS server device 2 has a processor such as a CPU or a microcomputer. As the processor executes a control program, the SNS control unit 21 comprehensively controls each part of the SNS server device 2. The SNS control unit 21 has a memory such as a ROM that stores the control program executed by the processor, in a non-volatile manner, and a RAM forming a work area of the processor, and an HDD (hard disk drive).

The SNS communication unit 22 is a communication interface that has a communication circuit including a communication IC and that communicates with an external device. The SNS communication unit 22 may be a wired communication interface to which a cable can be coupled, or a wireless communication interface.

Specifically, the SNS communication unit 22 may be, for example, a wired LAN interface conforming to Ethernet (trademark registered) or a wireless LAN interface conforming to the IEEE 802.11 standard.

The first server device 3 has a first control unit 31 and a first communication unit 32. The first server device 3 communicates with each of the SNS server device 2 and the second server device 4 by the first communication unit 32.

For example, the first server device 3 accepts the print instruction JA for the printer 5 from the SNS server device 2 and transmits the print instruction JA for the printer 5 to the second server device 4, by the first communication unit 32. The first server device 3 is an example of a “server device”.

The description of parts of the configuration of the first control unit 31 and the first communication unit 32 of the first server device 3 that are similar to parts of the configuration of the SNS control unit 21 and the SNS communication unit 22 of the SNS server device 2 is omitted.

The second server device 4 has a second control unit 41 and a second communication unit 42. The second server device 4 communicates with the first server device 3 and the printer 5 by the second communication unit 42.

For example, the second control unit 41 of the second server device 4 accepts the print instruction JA for the printer 5 from the first server device 3 by the second communication unit 42, generates a print job, and sends the print job as the print instruction JA to the printer 5. At this point, when a plurality of printers 5 are connected to the network NW, the second server device 4 can designate one printer 5 and can send the print job to the designated printer 5.

The description of parts of the configuration of the second control unit 41 and the second communication unit 42 of the second server device 4 that are similar to parts of the configuration of the SNS control unit 21 and the SNS communication unit 22 of the SNS server device 2 is omitted.

The printer 5 has a printer control unit 51 and a printer communication unit 52. The printer 5 receives the print job as the print instruction JA from the second server device 4 by the printer communication unit 52, executes the print job by the printer control unit 51, and thus prints. The printer 5 is, for example, an inkjet printer. The printer 5 is an example of a “printing device”.

In this embodiment, the printer 5 is an inkjet printer. However, the present disclosure is not limited to this embodiment. The printer 5 may be a dot impact printer or a laser printer.

The printer control unit 51 has a processor such as a CPU or a microcomputer. As the processor executes a control program, the printer control unit 51 comprehensively controls each part of the printer 5. The printer control unit 51 has a memory such as a ROM that stores the control program executed by the processor, in a non-volatile manner, and a RAM forming a work area of the processor, and an HDD.

The printer communication unit 52 is a communication interface that has a communication circuit including a communication IC and that communicates with the second server device 4. The printer communication unit 52 may be a wired communication interface to which a cable can be coupled, or a wireless communication interface.

Specifically, the printer communication unit 52 may be a wired LAN interface conforming to Ethernet (trademark registered) or a wireless LAN interface conforming to the IEEE 802.11 standard.

### 1-2. Functional Configuration of Smartphone

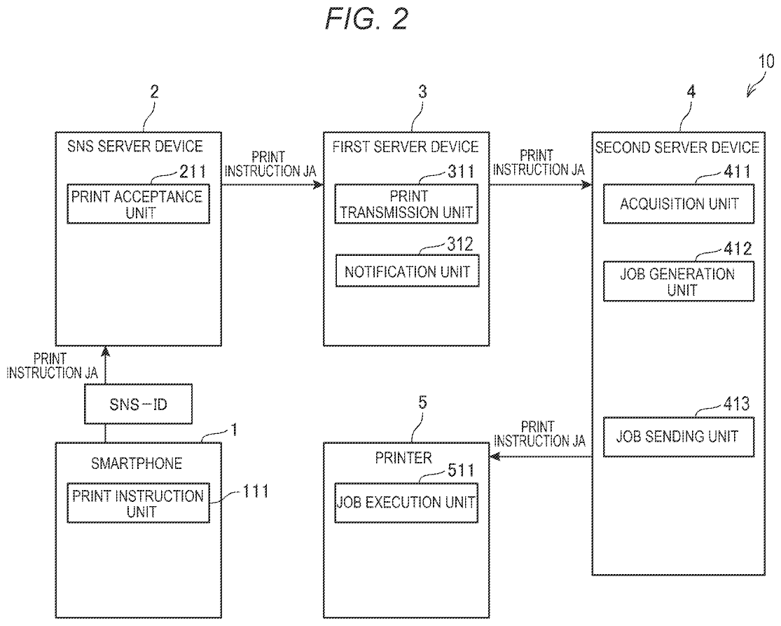

FIG. 2 shows an example of the functional configuration of the print control system 10. The terminal control unit 11 of the smartphone 1 functions as a print instruction unit 111.

Specifically, as the processor of the terminal control unit 11 of the smartphone 1 executes an application program, the terminal control unit 11 functions as the print instruction unit 111. The application program is, for example, an SNS application. An example of this is the LINE application.

The SNS application executed by the processor of the terminal control unit 11 of the smartphone 1 will now be described.

By the cooperation between the SNS server device 2 and the smartphone 1, an SNS is provided to the smartphone 1 of a user having an account. The SNS application executed by the smartphone 1 enables the user to log in to the use's own account and use the SNS.

The SNS server device 2 can also provide a chat system included in the SNS to the smartphone 1.

The SNS application includes an application related to the chat system. The smartphone 1 can also execute the chat system included in the SNS application.

The user operates the smartphone 1, performs input processing according to a predetermined rule in the chat system provided by the SNS server device 2, and thus can generate and use a group chat within the chat system.

The user enters the group chat in the chat system on the smartphone 1 and thus can chat with another user belonging to the same group chat.

The display panel of the display unit 13 of the smartphone 1 displays a message screen as a user interface.

The user inputs a print instruction for the printer 5 to the print instruction unit 111 via the touch sensor of the display unit 13.

Specifically, the user designates at least one of data or a file to be printed and a URL thereof in the group chat to which the user belongs in the chat system on the smartphone 1, and inputs a print instruction to the print instruction unit 111. An input to the chat system is also referred to as a post.

The print instruction unit 111 generates the print instruction JA, based on the inputted print instruction. The smartphone 1 sends the print instruction JA to the SNS server device 2. The print instruction JA includes print instruction information and information about the foregoing data or the like.

As shown in FIG. 2, the communication between the smartphone 1 and the SNS server device 2 is executed using an SNS-ID. The SNS-ID refers to user identification information in the SNS server device 2. The SNS-ID is, for example, a LINE-ID.

That is, the print instruction JA is sent from the smartphone 1 to the SNS server device 2 in association with the SNS-ID.

The print instruction JA sent to the SNS server device 2 includes the data or the file inputted by the user. The print instruction JA may include the URL (Uniform Resource Locator). The data or the file is data or a file that is printable by the printer 5. The URL is an address on the internet from which the data or the file can be downloaded, or the like.

The data included in the print instruction JA may also be, for example, image data of a photograph or the like, or text data of a document or the like. The format of the file included in the print instruction JA may be, for example, PDF (Portable Document Format), JPEG (Joint Photographic Experts Group) format, TIFF (Tagged Image File Format) or the like. The format of the file may also be, for example, other formats used for documents such as a text file format or a file format for spreadsheets.

### 1-3. Functional Configuration of SNS Server Device and First Server Device

The SNS server device 2 can provide the SNS on the internet. A shown in FIG. 2, the SNS control unit 21 of the SNS server device 2 functions as a print acceptance unit 211. Specifically, as the processor of the SNS control unit 21 of the SNS server device 2 executes the control program, the SNS control unit 21 functions as the print acceptance unit 211.

The print acceptance unit 211 receives the print instruction JA generated by the print instruction unit 111 of the smartphone 1 and transmits the received print instruction JA to the first server device 3.

The SNS server device 2 can also provide an API (Application Programming Interface). Specifically, the SNS application executed by the terminal control unit 11 of the smartphone 1 can send and receive information about printing to and from the first server device 3 via the API provided by the SNS server device 2.

As shown in FIG. 2, the first control unit 31 of the first server device 3 functions as a print transmission unit 311 and a notification unit 312. Specifically, as the processor of the first control unit 31 of the first server device 3 executes the control program, the first control unit 31 functions as the print transmission unit 311 and the notification unit 312 and thus can control printing for the printer 5, including whether the printing is available or not. The term “about printing” refers to at least one of print instruction and print execution.

An instruction such as the print instruction JA from the smartphone 1 to the first server device 3 and a notification from the first server device 3 to the smartphone 1 can be given via the chat system executed by the cooperation between the smartphone 1 and the SNS server device 2.

The instruction and the notification may also be executed using a browser or an email, without using the chat system.

The communication between the SNS server device 2 and the first server device 3, too, is executed using the SNS-ID. Specifically, the print instruction JA is transmitted from the SNS server device 2 to the first server device 3 in association with the SNS-ID.

In the example of this embodiment, the communication between the first server device 3, the second server device 4, and the printer 5 is performed by sending and receiving an email using each email address on the network NW, without using the SNS provided by the SNS server device 2.

The user can register in advance the SNS-ID and the email address corresponding to the second server device 4 in association with each other in the first server device 3, using the SNS application executed by the smartphone 1.

In this case, the SNS-ID and the email address corresponding to the second server device 4 are stored in association with each other in the HDD or the memory of the first control unit 31 of the first server device 3.

The user can also register in advance the SNS-ID and the email address corresponding to the designated printer 5 in association with each other in the first server device 3, using the SNS application executed by the smartphone 1.

In this case, the SNS-ID and the email address corresponding to the designated printer 5 are stored in association with each other in the HDD or the memory of the first control unit 31 of the first server device 3.

The notification unit 312 of the first server device 3 can determine whether the printing based on the print instruction JA is available or not, generate a notification of the result of the determination, and send the notification to the smartphone 1 via the SNS server device 2.

The terminal control unit 11 of the smartphone 1 can display the notification via the message screen on the display panel of the display unit 13. Specifically, the smartphone 1 can display the notification on the display unit 13, using the chat system.

The print transmission unit 311 of the first server device 3 receives the print instruction JA from the SNS server device 2, refers to the HDD or the memory, based on the SNS-ID, and adds the email address of the corresponding printer 5 to the print instruction JA. The printer 5 corresponding to the SNS-ID is the printer 5 designated in advance by the user.

The print transmission unit 311 transmits the print instruction JA with the email address of the printer 5 added, from the first server device 3 to the second server device 4, using the email address of the second server device 4.

### 1-4. Functional Configuration of Second Server Device

As shown in FIG. 2, the second control unit 41 of the second server device 4 functions as an acquisition unit 411, a job generation unit 412, and a job sending unit 413. Specifically, as the processor of the second control unit 41 of the second server device 4 executes the control program, the second control unit 41 functions as the acquisition unit 411, the job generation unit 412, and the job sending unit 413.

The acquisition unit 411 of the second server device 4 acquires the print instruction JA from the SNS via the first server device 3. Specifically, the acquisition unit 411 acquires the print instruction JA from the smartphone 1 sequentially via the SNS server device 2 and the first server device 3. In the direct term, the acquisition unit 411 acquires the print instruction JA from the SNS server device 2.

In other words, “acquiring from the SNS” also means “acquiring from the SNS server device 2”.

The print instruction JA acquired by the acquisition unit 411 includes the email address of the designated printer 5.

The second control unit 41 of the second server device 4 can manage a plurality of printers 5. In this case, the memory of the second control unit 41 can store, for example, a model name, a serial number, an ID, an email address, and the like, which are printer information of each printer 5, in association with each other.

In the memory of the second control unit 41, a driver of each printer 5 is installed in association with these pieces of information.

The job generation unit 412 of the second server device 4 refers to the memory of the second control unit 41, based on the email address of the designated printer 5 included in the print instruction JA, and thus can execute the driver of the printer 5 corresponding to the email address.

The job generation unit 412 executes the driver of the designated printer 5, based on the print instruction JA, and thus can generate a print job.

The job sending unit 413 sends the print job generated by the job generation unit 412, as the print instruction JA, to the email address of the designated printer 5.

The first control unit 31 of the first server device 3 may include the functions of the acquisition unit 411, the job generation unit 412, and the job sending unit 413 of the second server device 4.

In this case, the first server device 3 can include the second server device 4. That is, the print control system 10 can be configured to exclude the second server device 4 and include the smartphone 1, the SNS server device 2, and the first server device 3.

### 1-5. Functional Configuration of Printer

As shown in FIG. 2, the printer control unit 51 of the printer 5 functions as a job execution unit 511. Specifically, as the processor of the printer control unit 51 of the printer 5 executes the control program, the printer control unit 51 functions as the job execution unit 511.

The job execution unit 511 executes the print job which is the print instruction JA sent from the job sending unit 413, and thus can print.

### 2. Control Method for First Server Device

### 2-1. First Embodiment

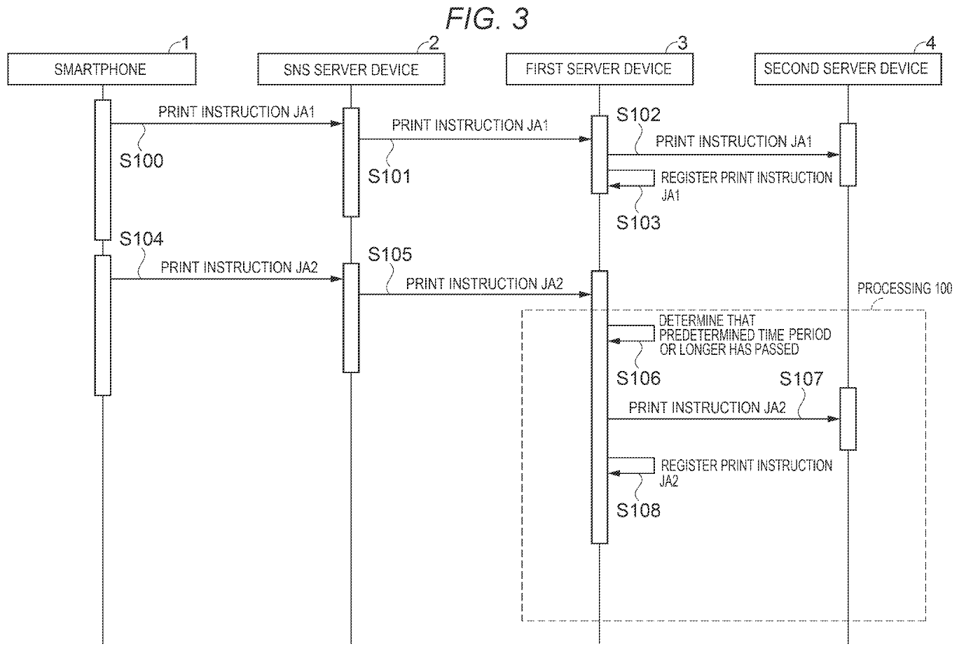

A first embodiment in which a second print instruction JA2 of the second time is sent with the lapse of a predetermined time period or longer after a first print instruction JA1 of the first time is sent, as shown in FIG. 3, will now be described. In FIGS. 3, 4, 6, and 7, the first print instruction JA1 and the second print instruction JA2 are simply referred to as “print instruction JA1” and “print instruction JA2”.

First, the processing of the print instruction JA1 of the first time in the print control system 10 will be described.

With the smartphone 1, the user designates first data or a first file to be printed or a first URL thereof, or the like via an SNS chat system provided by the SNS server device 2 and inputs a print instruction from the display unit 13.

The terminal control unit 11 of the smartphone 1 generates the first print instruction JA1 of the first time including one of the first data, the first file, the first URL or the like, based on the print instruction of the first time inputted from the display unit 13, and sends the first print instruction JA1 in association with the SNS-ID to the SNS server device 2 by the terminal communication unit 12 (S100).

The SNS control unit 21 of the SNS server device 2 receives the first print instruction JA1 from the smartphone 1 and sends the first print instruction JA1 in association with the SNS-ID to the first server device 3, by the SNS communication unit 22 (S101).

The first communication unit 32 of the first server device 3 can communicate with the smartphone 1 via the SNS server device 2, using the chat system.

The first control unit 31 of the first server device 3 receives the first print instruction JA1 from the SNS server device 2 and sends the first print instruction JA1 to the second server device 4, using the email address of the registered second server device 4, by the first communication unit 32 (S102).

When communicating with the printer 5 via the second server device 4, the first communication unit 32 of the first server device 3 can communicate using the email address, instead of using the chat system.

The first control unit 31 of the first server device 3 adds the email address of the designated printer 5 corresponding to the registered SNS-ID to the first print instruction JA1.

When the first control unit 31 has received the first print instruction JA1 from the SNS server device 2, the first control unit 31 acquires and registers a first time point that is the time point of reception, and information about the first data, the first file, the first URL or the like included in the first print instruction JA1 (S103).

After that, though not illustrated in FIG. 3, the second control unit 41 of the second server device 4 receives the first print instruction JA1 from the first server device 3 by the second communication unit 42, generates a first print job, using the email address of the printer 5 added thereto, and sends the first print job as the first print instruction JA1 to the designated printer 5.

The printer control unit 51 of the printer 5 then receives the first print instruction JA1 from the second server device 4 by the printer communication unit 52 and performs printing based on the first print job.

Although not illustrated in FIG. 3, when the first control unit 31 of the first server device 3 has accepted the first print instruction JA1, the notification unit 312, which is the first control unit 31, generates a first notification including information to the effect that the first print instruction JA1 is accepted, and sends the first notification to the SNS server device 2 by the first communication unit 32.

The SNS control unit 21 of the SNS server device 2 sends the first notification received from the first server device 3 to the smartphone 1 by the SNS communication unit 22.

In this way, the first control unit 31 of the first server device 3 sends the first notification to the smartphone 1 via the SNS server device 2 by the first communication unit 32.

The terminal control unit 11 of the smartphone 1 receives the first notification from the SNS server device 2 by the terminal communication unit 12.

The smartphone 1 can display the first notification on the display unit 13 via the SNS chat system provided by the SNS server device 2. The user views the first notification displayed on the display unit 13 of the smartphone 1 and thus knows that the first print instruction JA1 is accepted and that printing is performed.

The processing of the second print instruction JA2 of the second time will now be described mainly in terms of processing 100 as the first embodiment of the first server device 3. The description of parts of the processing of the second print instruction JA2 in the print control system 10 that are similar to the foregoing processing of the first print instruction JA1 is partly omitted.

The terminal control unit 11 of the smartphone 1 generates the second print instruction JA2 of the second time including one of second data, a second file, a second URL or the like, based on a print instruction of the second time inputted from the display unit 13, and sends the second print instruction JA2 to the SNS server device 2 by the terminal communication unit 12 (S104).

The SNS control unit 21 of the SNS server device 2 receives the second print instruction JA2 from the smartphone 1 and sends the second print instruction JA2 in association with the SNS-ID to the first server device 3, by the SNS communication unit 22 (S105).

The first control unit 31 of the first server device 3 receives the second print instruction JA2 from the SNS server device 2. The processing 100 executed by the first control unit 31 of the first server device 3 will now be described.

When the first control unit 31 has received the second print instruction JA2 from the SNS server device 2, the first control unit 31 acquires a second time point of reception and information about the second data, the second file, the second URL or the like included in the second print instruction JA2.

That is, the first communication unit 32 of the first server device 3 receives the second print instruction JA2 of the second time at the second time point after receiving the first print instruction JA1 of the first time at the first time point.

The first control unit 31 of the first server device 3 calculates the time period from the first time point to the second time point, and makes the execution of the printing based on the second print instruction JA2 available at the printer 5 when it is determined that this time period is equal to or longer than a predetermined time period. Whether to make the execution of the printing available at the designated printer 5 or not, by the first control unit 31, may also be simply referred to as whether to make the printing available or not. The first control unit 31 can control whether the printing is available at the printer 5 or not.

That is, when the first control unit 31 has determined that the second time point is a time point when a predetermined time period or longer has passed after the first time point (S106), the first control unit 31 determines that the printer 5 is made to execute the printing. The predetermined time period may be, for example, any time period of 0.1 seconds to 60 seconds.

When the first control unit 31 of the first server device 3 has made the execution of the printing based on the second print instruction JA2 available at the printer 5, the first control unit 31 performs processing as in the case of the first print instruction JA1.

That is, the first control unit 31 sends the second print instruction JA2 to the second server device 4 (S107).

The second server device 4 receives the second print instruction JA2, generates a print job, and sends the print job to the printer 5. The printer 5 receives the print job, which is the second print instruction JA2, from the second server device 4, and performs printing.

The first control unit 31 of the first server device 3 registers the second time point, which is the time point when the second print instruction JA2 is received, and the information about the second data, the second file, the second URL or the like included in the second print instruction JA2 (S108).

The first control unit 31 may register these pieces of information when receiving the second print instruction JA2.

Although not illustrated in FIG. 3, when the first control unit 31 of the first server device 3 has determined that the execution of the printing based on the second print instruction JA2 is available at the printer 5, the notification unit 312 generates a first notification and sends the first notification to the SNS server device 2, as in the case of the first print instruction JA1. The SNS server device 2 sends the first notification received from the first server device 3 to the smartphone 1. In this way, the first control unit 31 can control whether the printing is available at the printer 5 or not.

When the smartphone 1 has received the first notification from the SNS server device 2, the smartphone 1 can display the first notification on the display unit 13 by the chat system.

### 2-2. Second Embodiment

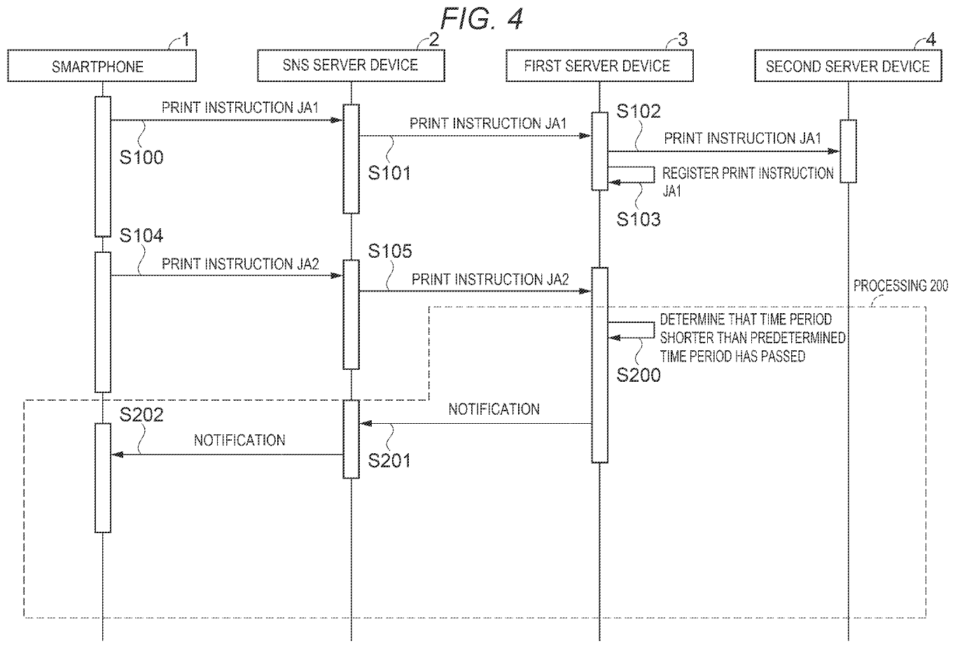

The case where the second print instruction JA2 of the second time is sent with the lapse of a time period shorter than a predetermined time period after the first print instruction JA1 of the first time is sent from the smartphone 1 to the SNS server device 2, as shown in FIG. 4, will now be described.

The processing of the second print instruction JA2 of the second time will be described mainly in terms of processing 200 as a second embodiment of the first server device 3.

The processing of the first print instruction JA1 of the first time in the print control system 10 is similar to the processing in the first embodiment and therefore is denoted in FIG. 4 by the same reference signs as in FIG. 3 and is not described further in detail.

Parts of the processing of the second print instruction JA2 of the second time in the print control system 10 that are similar to parts in the first embodiment are denoted in FIG. 4 by the same reference signs as in FIG. 3 and are not described further in detail. Also, the description of other parts similar to parts in the first embodiment is partly omitted.

The SNS server device 2 receives the second print instruction JA2 from the smartphone 1 and sends the second print instruction JA2 to the first server device 3 (S105).

When the first server device 3 has received the second print instruction JA2 of the second time from the SNS server device 2, the first server device 3 acquires the second time point of reception and the information about the second data, the second file, the second URL or the like included in the second print instruction JA2.

The first control unit 31 of the first server device 3 calculates the time period from the first time point to the second time point and makes the execution of the printing based on the second print instruction JA2 unavailable at the printer 5 when it is determined that this time period is shorter than a predetermined time period.

That is, when the first control unit 31 has determined that the second time point is a time point when only a time period shorter than the predetermined time period has passed after the first time point (S200), the first control unit 31 determines that the printing is not executed at the printer 5.

In some cases, the SNS server device 2 may repeatedly receive a print instruction from the smartphone 1 during a predetermined time period. Even in such cases, the first server device 3 can prevent the execution of printing that is not intended by the user.

When the first control unit 31 of the first server device 3 has determined that the execution of the printing based on the second print instruction JA2 is unavailable at the printer 5, the notification unit 312, which is the first control unit 31, generates a second notification including information about an error or the like and sends the second notification to the SNS server device 2 by the first communication unit 32 (S201). In FIGS. 4, 6, and 7, the second notification is simply referred to as “notification”.

The second notification may include information to the effect that the execution of the printing based on the second print instruction JA2 is unavailable at the printer 5. The first control unit 31 does not send the second print instruction JA2 to the second server device 4.

In this way, the first control unit 31 can control whether the printing is available at the printer 5 or not.

The SNS control unit 21 of the SNS server device 2 sends the second notification received from the first server device 3 to the smartphone 1 by the SNS communication unit 22 (S202).

In this way, the first control unit 31 of the first server device 3 sends the second notification to the smartphone 1 via the SNS server device 2 by the first communication unit 32.

The terminal control unit 11 of the smartphone 1 receives the second notification from the SNS server device 2 by the terminal communication unit 12.

The smartphone 1 can display the second notification on the display unit 13 via the SNS chat system provided by the SNS server device 2. The user views the second notification displayed on the display unit 13 of the smartphone 1 and thus knows that the second print instruction JA2 has resulted in an error and that printing is not performed.

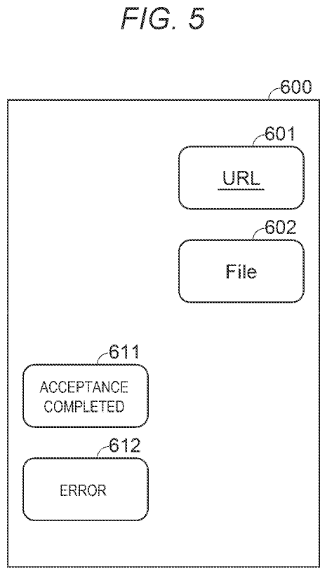

FIG. 5 shows an example of a message screen 600 of the chat system displayed on the display unit 13 of the smartphone 1.

At a right part of the message screen 600, an indication 601 of “URL” indicating the inputted first URL corresponding to the first print instruction JA1 is displayed. Below that, an indication 602 of “File” indicating the inputted second file corresponding to the second print instruction JA2 is displayed.

At a left part of the message screen 600, an indication 611 of “Acceptance Completed” indicating the first notification to the effect that the first server device 3 has accepted the first print instruction JA1 is displayed. Below that, an indication 612 of “Error” indicating the second notification to the effect that the first server device 3 has made the execution of the printing based on the second print instruction JA2 unavailable at the printer 5 is displayed. The indication 611 of “Acceptance Completed” indicating the first notification and the indication 612 of “Error” indicating the second notification are displayed in parallel.

The user knows that the printing based on the first print instruction JA1 of the first time has been executed, based on the indication 611 of “Acceptance Completed”, and knows that the printing based on the second print instruction JA2 of the second time has not been executed, based on the indication 612 of “Error”.

### 2-3. Third Embodiment

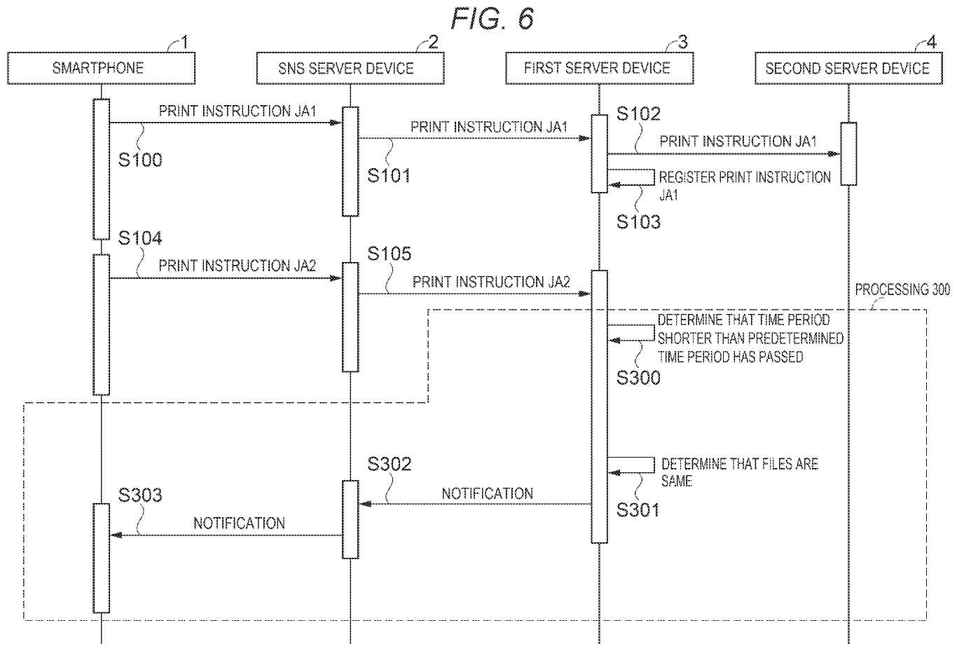

It is assumed that the second print instruction JA2 of the second time is sent with the lapse of a time period shorter than a predetermined time period after the first print instruction JA1 of the first time is sent from the smartphone 1 to the SNS server device 2, as shown in FIG. 6.

The case where the second file or the second data included in the second print instruction JA2 of the second time is the same as the first file or the first data included in the first print instruction JA1 of the first time will be described mainly in terms of processing 300 as a third embodiment of the first server device 3.

As in the description of the second embodiment, the description of the same or similar parts is partly omitted.

It is assumed that the first server device 3 receives the first print instruction JA1 of the first time from the SNS server device 2 and acquires and registers the first time point of reception and the information about the first file or the first data included in the first print instruction JA1 (S103).

The SNS server device 2 receives the second print instruction JA2 of the second time from the smartphone 1 and sends the second print instruction JA2 to the first server device 3 (S105).

When the first server device 3 has received the second print instruction JA2 from the SNS server device 2, the first server device 3 acquires the second time point of reception and the information about the second file or the second data included in the second print instruction JA2.

The first control unit 31 of the first server device 3 calculates the time period from the first time point to the second time point and determines that this time period is shorter than a predetermined time period. That is, the first control unit 31 determines that the second time point is a time point when only a time period shorter than the predetermined time period has passed after the first time point (S300).

The first control unit 31 also compares the first file or the first data included in the first print instruction JA1 with the second file or the second data included in the second print instruction JA2.

The second print instruction JA2 of the second time is the print instruction JA immediately after the first print instruction JA1 of the first time. The first control unit 31 compares the nearest two print instructions JA.

When the first control unit 31 has determined that the first file and the second file are the same or that the first data and the second data are the same (S301), the first control unit 31 determines that the printing based on the second print instruction JA2 is not executed at the printer 5. In FIG. 6, the illustration of the determination about the same data is omitted.

The first control unit 31 can determine whether the first file and the second file are the same or not, based on at least one of whether the data are the same or not, whether the file names are the same or not, whether the file sizes are the same or not, and whether the time stamps are the same or not. The first control unit 31 may also determine whether the first file and the second file are the same or not, based on a combination of these.

In this way, when the first control unit 31 of the first server device 3 has determined that the execution of the printing based on the second print instruction JA2 is unavailable at the printer 5, the notification unit 312 generates the second notification indicating an error or the like and sends the second notification to the SNS server device 2 (S302). The first control unit 31 does not send the second print instruction JA2 to the second server device 4. In this way, the first control unit 31 can control whether the printing is available at the printer 5 or not.

The SNS server device 2 sends the second notification received from the first server device 3 to the smartphone 1 (S303).

The smartphone 1 receives the second notification from the SNS server device 2 and displays the second notification on the display unit 13 via the chat system. The user views the second notification displayed on the display unit 13 of the smartphone 1 and thus knows that the second print instruction JA2 of the second time has resulted in an error and that printing is not performed.

In some cases, the SNS server device 2 may repeatedly receive a print instruction of the same content from the smartphone 1 during a predetermined time period. Even in such cases, the first server device 3 can prevent the execution of printing that is not intended by the user.

### 2-4. Fourth Embodiment

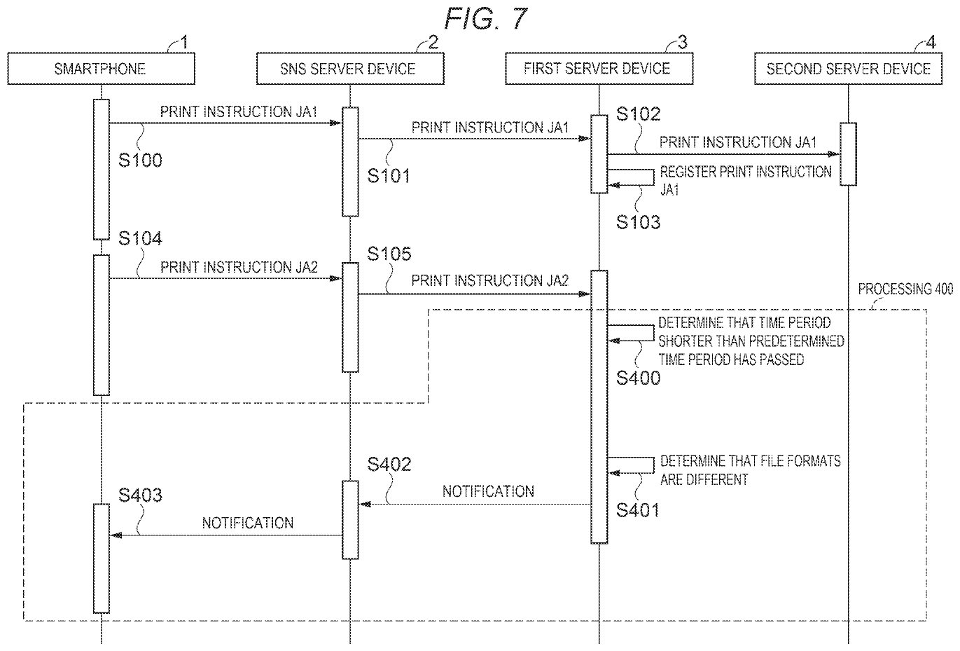

It is assumed that the second print instruction JA2 of the second time is sent with the lapse of a time period shorter than a predetermined time period after the first print instruction JA1 of the first time is sent from the smartphone 1 to the SNS server device 2, as shown in FIG. 7.

The case where a second file format of the second file included in the second print instruction JA2 of the second time is different from a first file format of the first file included in the first print instruction JA1 of the first time will be described mainly in terms of processing 400 as a fourth embodiment of the first server device 3.

As in the description of the third embodiment, the description of the same or similar parts is partly omitted.

It is assumed that the first server device 3 receives the first print instruction JA1 of the first time from the SNS server device 2 and acquires and registers the first time point of reception and the first file format, which is information about the first file included in the first print instruction JA1 (S103).

The SNS server device 2 receives the second print instruction JA2 of the second time from the smartphone 1 and sends the second print instruction JA2 to the first server device 3 (S105).

When the first server device 3 has received the second print instruction JA2 from the SNS server device 2, the first server device 3 acquires the second time point of reception and the second file format, which is information about the second file included in the second print instruction JA2.

The first control unit 31 of the first server device 3 calculates the time period from the first time point to the second time point and determines that this time period is shorter than a predetermined time period. That is, the first control unit 31 determines that the second time point is a time point when only a time period shorter than the predetermined time period has passed after the first time point (S400).

The first control unit 31 also compares the first file format included in the first print instruction JA1 with the second file format included in the second print instruction JA2.

When the first control unit 31 has determined that the first file format and the second file format are different from each other (S401), the first control unit 31 determines that the printing based on the second print instruction JA2 is not executed at the printer 5.

For example, when the first file format is the PDF format whereas the second file format is the JPEG format, the first control unit 31 determines that the file formats are different from each other. Also, the first control unit 31 can also define, for example, a URL as a file format, and can determine that the file formats are different from each other when the first file format is the PDF format whereas the second file format is the second URL.

In some cases, the SNS server device 2 may repeatedly receive a print instruction of the same content in different file formats from the smartphone 1 during a predetermined time period. Even in such cases, the first server device 3 can prevent the execution of printing that is not intended by the user.

In this way, when the first control unit 31 of the first server device 3 has determined that the execution of the printing based on the second print instruction JA2 is unavailable at the printer 5, the notification unit 312 generates the second notification indicating an error or the like and sends the second notification to the SNS server device 2 (S402). The first control unit 31 does not send the second print instruction JA2 to the second server device 4. In this way, the first control unit 31 can control whether the printing is available at the printer 5 or not.

The SNS server device 2 sends the second notification received from the first server device 3 to the smartphone 1 (S403).

The smartphone 1 receives the second notification from the SNS server device 2 and displays the second notification on the display unit 13 via the chat system. The user views the second notification displayed on the display unit 13 of the smartphone 1 and thus knows that the second print instruction JA2 of the second time has resulted in an error and that printing is not performed.

As described above, the first server device 3 has the first communication unit 32 configured to be able to communicate with the smartphone 1 via the SNS server device 2 providing the SNS, and the first control unit 31 configured to be able to control whether the execution of printing is available at the printer 5 or not. The first control unit 31 receives the second print instruction JA2 at the second time point after receiving the first print instruction JA1 at the first time point, by the first communication unit 32, and makes the execution of the printing based on the second print instruction JA2 unavailable at the printer 5 when it is determined that the time period from the first time point to the second time point is shorter than a predetermined time period.

Even when the SNS server device 2 repeatedly receives a print instruction from the smartphone 1 during a predetermined time period, the first server device 3 can prevent the execution of printing that is not intended by the user. Thus, convenience can be improved.

The embodiments have been described in detail with reference to the drawings. However, the present disclosure is not limited to the specific configurations or the like described in the embodiments. Changes, replacements, deletions and the like can be made without departing from the spirit and scope of the present disclosure.

For example, the first print instruction JA1 of the first time and the second print instruction JA2 of the second time can be adapted as an n-th print instruction JAn of the n-th time and an (n+1) th print instruction JA (n+1) of the (n+1) th time, where n is any natural number.

What is claimed is:

1. A server device comprising:
a communication unit configured to be able to communicate with a terminal device via an SNS server device providing a social networking service; and
a controller configured to be able to control whether printing is available at a printing device or not, wherein
the controller
receives a second print instruction at a second time point after receiving a first print instruction at a first time point by the communication unit, and
makes printing based on the second print instruction unavailable at the printing device when it is determined that a time period from the first time point to the second time point is shorter than a predetermined time period.

2. The server device according to claim 1, wherein
the first print instruction includes a first file or first data, and the second print instruction includes a second file or second data, and
the controller
makes the printing based on the second print instruction unavailable at the printing device when it is determined that the first file and the second file are the same or when it is determined that the first data and the second data are the same,
when it is determined that the time period from the first time point to the second time point is shorter than the predetermined time period.

3. The server device according to claim 1, wherein
the first print instruction includes a first file, and the second print instruction includes a second file,
the controller
makes the printing based on the second print instruction unavailable at the printing device when it is determined that a format of the first file and a format of the second file are different from each other,
when it is determined that the time period from the first time point to the second time point is shorter than the predetermined time period.

4. The server device according to claim 1, further comprising:
a notification unit that generates a notification, based on whether printing is available at the printing device or not, wherein
the notification unit generates a first notification when printing based on the first print instruction is made available at the printing device, and generates a second notification when the printing based on the second instruction is made unavailable at the printing device, and
the controller sends the first notification or the second notification to the terminal device via the SNS server device by the communication unit.

5. A control method for a server device that is configured to be able to communicate with a terminal device via an SNS server device providing a social networking service and that is configured to be able to control whether printing is available at a printing device or not, the control method comprising:
receiving a second print instruction at a second time point after receiving a first print instruction at a first time point; and
making printing based on the second print instruction unavailable at the printing device when it is determined that a time period from the first time point to the second time point is shorter than a predetermined time period.

6. A print control system comprising:
an SNS server device that provides a social networking service;
a server device configured to be able to communicate with a terminal device via the SNS server device; and
a printing device, wherein
the server device
is configured to be able to control whether printing is available at the printing device or not,
receives a second print instruction inputted to the terminal device, at a second time point, after receiving a first print instruction inputted to the terminal device, at a first time point, from the SNS server device, and
makes printing based on the second print instruction unavailable at the printing device when it is determined that a time period from the first time point to the second time point is shorter than a predetermined time period.
